(19) United States
(12) Patent Application Publication
(10) Pub. No.: US 2013/0057663 A1
(43) Pub. Date: Mar. 7, 2013

(54) IMAGE VIEWING SYSTEMS WITH DYNAMICALLY RECONFIGURABLE SCREENS FOR THREE-DIMENSIONAL VIEWING

(71) Applicants: Alexandre M. Bratkovski, Mountain View, CA (US); Huei Pei Kuo, Cupertino, CA (US); Peter George Hartwell, Sunnyvale, CA (US)

(72) Inventors: Alexandre M. Bratkovski, Mountain View, CA (US); Huei Pei Kuo, Cupertino, CA (US); Peter George Hartwell, Sunnyvale, CA (US)

(21) Appl. No.: 13/695,333

(22) PCT Filed: Apr. 30, 2010
(86) PCT No.: PCT/US10/33273

§ 371 Date: Oct. 30, 2012

(51) Int. Cl. G02B 27/22; H04N 13/04

(52) U.S. Cl. 348/55; 353/7; 348/E13.075; 348/E13.058

(57) ABSTRACT

Various embodiments of the present invention are directed to image viewing systems. In one aspect, an image viewing system includes a projection system (104, 504, 604), and a dynamically reconfigurable screen (102, 502, 602). The projection system projects two or more images of perspective views of objects or a scene onto the screen. The screen is dynamically reconfigured to separately reflect each image to an associated viewing zone, enabling a viewer looking at the screen to the view the objects or the scene from different viewing zones

### TECHNICAL FIELD

Embodiments of the present invention relate to three-dimensional display technology and microelectromechanical systems.

### BACKGROUND

In recent years, the advent of stereo display technologies enabling viewers to view objects in three-dimensions with two-dimensional displays has been gaining interest and acceptance. With typical stereo display technology, viewers are required to wear eye glasses that control the visual content delivered to each eye. However, it is typically the case that the relative orientations of the projections received by the viewer are correct only for certain viewing locations, such as locations where a viewer's view is orthogonal to the center of a display. By contrast, viewers watching the same display outside these viewing locations experience a re-projection error that manifests as a vertical misalignment of the visual content received by the eyes of the viewers. If the images are very different, then in some cases one image at a time may be seen, a phenomenon known as binocular rivalry. Another type of visual artifact in typical stereo display technologies is that foreground and background objects often appear with the same focus.

However, a typical three-dimensional display often yields distortions in images of three-dimensional structures when compared with the real scenes as a result of displaying three-dimensional images on a single two-dimensional surface. For example, focusing cues such as accommodation and blur in a retinal image specify the depth of the display rather than the depths objects in the images displayed. Moreover, typical three-dimensional displays produce three-dimensional images by uncoupling vergence and accommodation, which often reduces a viewer's ability to effectively combine stereo image pairs and may cause viewer discomfort and fatigue. Thus, mere below threshold objectionableness may not be sufficient for permitting the presence of such artifacts.

Designers and manufacturers of three-dimensional display systems continue to seek improvements that reduce the adverse effects associated with typical stereo display technology.

### BRIEF DESCRIPTION OF THE. DRAWINGS

FIG. 1 shows a general schematic representation of an image viewing system configured in accordance with one or more embodiments of the present invention.

FIG. 2 shows an example of a dynamically reconfigurable screen configured in accordance with one or more embodiments of the present invention,

FIG. 3 shows three examples of mirrors plates of a dynamically reconfigurable screen, the mirror plates rotated about different axes in accordance with one or more embodiments of the present invention.

FIG. 4 shows two example sub-regions of a dynamically reconfigurable screen in accordance with one or more embodiments of the present invention.

FIG. 5 shows a top view of a schematic representation of a first example viewing system configured in accordance with one or more embodiments of the present invention.

FIG. 6 shows a top view of a schematic representation of a second example viewing system configured in accordance with one or more embodiments of the present invention,

FIG. 7A shows a plot of example sub-time slots associated with a projector time slot in accordance with one or more embodiments of the present invention.

FIG. 7B shows an example of perspective views of a red ball and a blue ball in accordance with one or more embodiments of the present invention.

FIG. 8 shows a top view of a viewer capturing different perspective views in each eye for different viewing zones in accordance with one or more embodiments of the present invention,

FIG. 9 shows a flow diagram of a method for viewing images from different viewing zones in accordance with one or more embodiments of the present invention.

### DETAILED DESCRIPTION

Various embodiments of the present invention are directed to image viewing systems that include a projection system and a dynamically reconfigurable reflective screen for viewing different perspective views of objects and scenes in two or three dimensions from different viewing zones. The reconfigurable screen is composed of an array of microdectromechanical system (“MEMS”) mirrors enabling the screen to reflect images of different perspective views of objects or a scene to different viewing zones.

Embodiments of the present invention allow viewers to experience three-dimensional imagery without having to wear glasses or goggles and viewers can see three-dimensional imagery with correct perspective views. When the spacing between the perspective views is larger than the spacing between the viewer's eyes, viewer's are presented with multiple two-dimensional perspective views separated by three-dimensional perspective views.

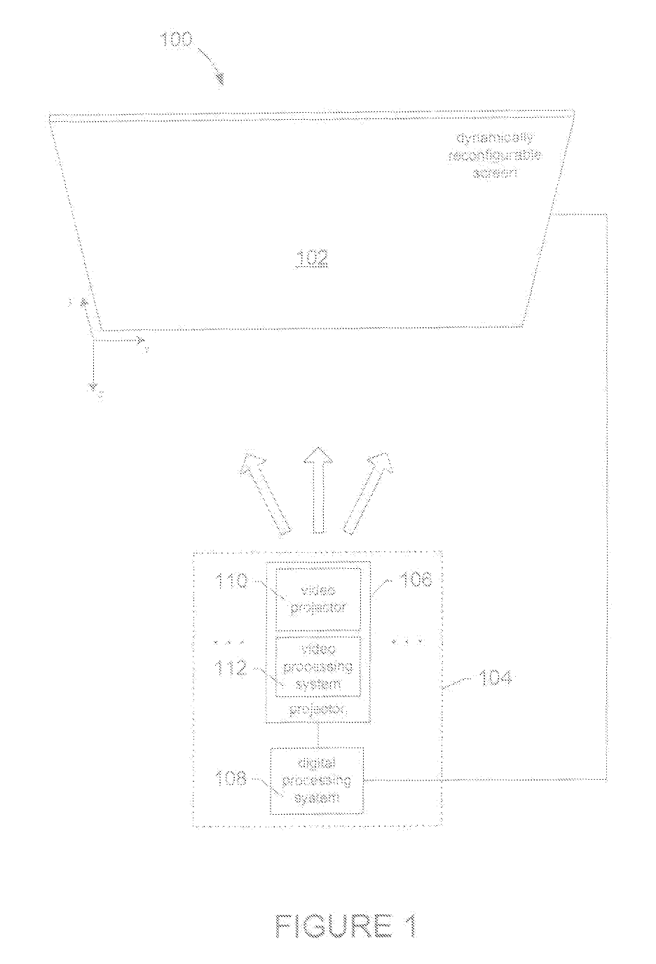

FIG. 1 shows an example schematic representation of an image viewing system 100. The viewing system 100 includes a dynamically reconfigurable screen 102 and a projection system 104. The projection system 104 includes one or more projectors 106 and a digital processing system 108. Each projector 106 includes a video projector 110 and a video processing system 112. The video projector 110 can be a liquid-crystal display (“LCD”) projector, a digital light processing (“DLP”) projector, a liquid crystal on silicon (“LCOS”) projector, a light-emitting diode (“LED”) projector, or a cathode ray tube (“CRT”) projector, just to name a few. The video processing system 112 can include a computer-readable medium and one or more processors for storing, processing, transmitting image data, and controlling the video projector 110. The digital processing system 108 is a computing device that includes firmware or software that synchronizes operation of the projectors 106 and the screen 102, as described below for various embodiments,

### Dynamically Reconfurable Screens

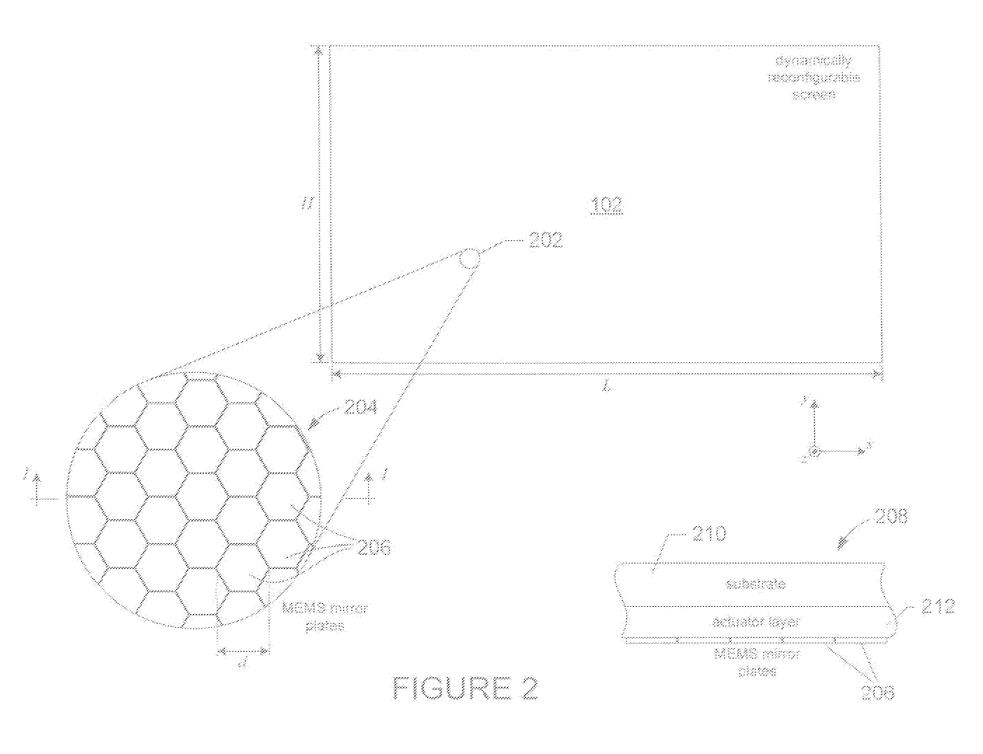

FIG. 2 shows a front view of an example dynamically reconfigurable screen 102. The screen 102 includes a reflective surface, a small portion 202 of which is magnified in enlargement 204. In the example shown in FIG. 2, the enlargement 204 reveals that the reflective surface is composed of a plurality of adjacent, hexagonal-shaped MEMS mirror plates 206. FIG. 2 also includes a cross-sectional view 208 of the portion 202 along a line I-I. The cross-sectional view 208 reveals the structure of the screen 202 includes a substrate 210 that supports an actuator layer 212. The height, if, and length, L, or aspect ratio of the screen 102 can be selected to fit any kind of front projection viewing environment. For example, the screen 102 can be fabricated to operate in a home theater, cinema, or conference room.

For the sake of convenience, operation of the screen 102 configured with hexagonal-shaped mirror plates is used to describe various viewing system embodiments. However, embodiments of the present invention are not intended to be so limited. In other embodiments, the mirror plates of the dynamically reconfigurable screen 102 can be octagonal, heptagonal, pentagonal, square, rectangular, triangular, circular, elliptical, and any other suitable shape, or combination of shapes, for reflecting images projected onto the reflective surface of the screen 102 and neighboring mirror plates can be positioned adjacent to one another without hindering the reorientation of neighboring mirror plates during operation of the screen 102.

In certain embodiments, the actuator layer 212 can be composed of individual actuators, each actuator mechanically coupled to a corresponding mirror plate 206 and operated to change the orientation of the corresponding plate 206. In other embodiments, the actuator layer 212 can be composed a number of actuators, each actuator mechanically coupled to two or more mirror plates that are moved simultaneously into the same orientation.

For purposes of describing operation of the screen 102, when the mirror plates are oriented parallel to the xy-plane of the screen 102, the mirror plates have 0° angle of rotation. The mirror plates can be rotated into a particular orientation about an imaginary axis with the angle of rotation ranging from about −30° to about 30°.

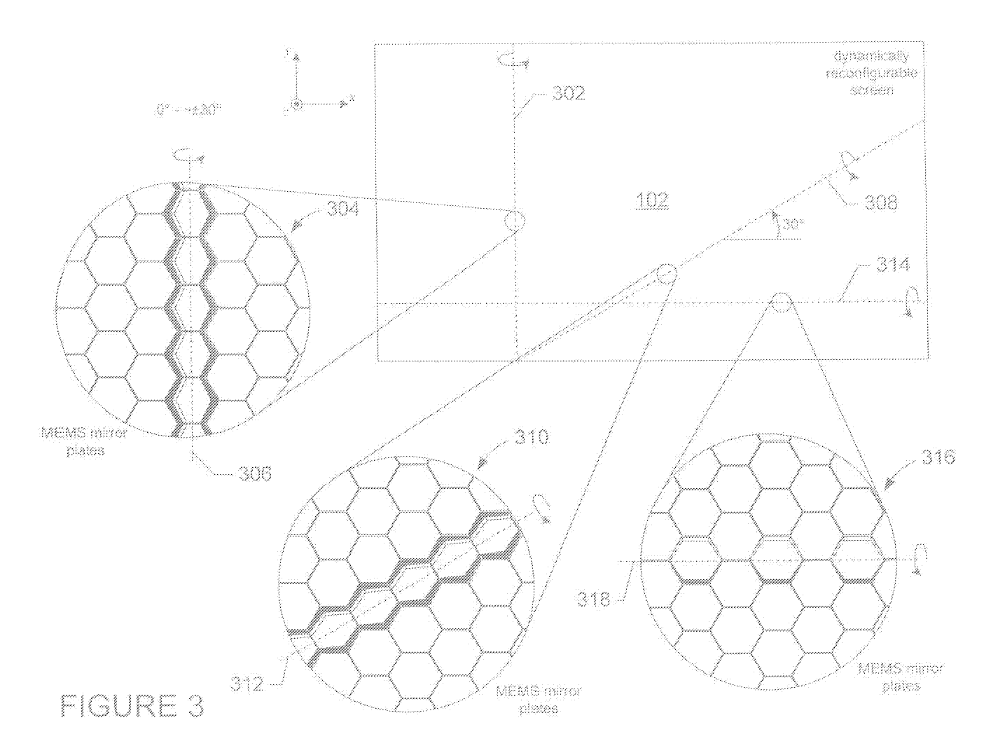

In certain embodiments, columns, rows, and mirror plates located along diagonals extending across the screen 102 can be rotated simultaneously with the same angle of rotation. FIG. 3 shows three examples of mirrors plates rotated about different axes. Dashed line 302 represents an entire column of mirror plates rotated with the same angle of rotation about an axis extending in the y-direction. Enlargement 304 shows a portion of the minor plates represented by line 302, the mirror plates rotated with the same angle of rotation about an imaginary axis 306. Dashed line 308 represents mirror plates are rotated with the same angle of rotation about an axis of rotation extending 30° above the x-direction. Enlargement 310 shows a portion of the mirror plates represented by the line 308. The minor plates rotated with the same angle of rotation about an imaginary axis 312. Dashed line 314 represents a row of mirror plates rotated with the same angle of rotation about an axis extending in the x-direction. Enlargement 316 shows a portion of the mirror plates represented by the line 314. The mirror plates are rotated with the same angle of rotation about an imaginary axis 318.

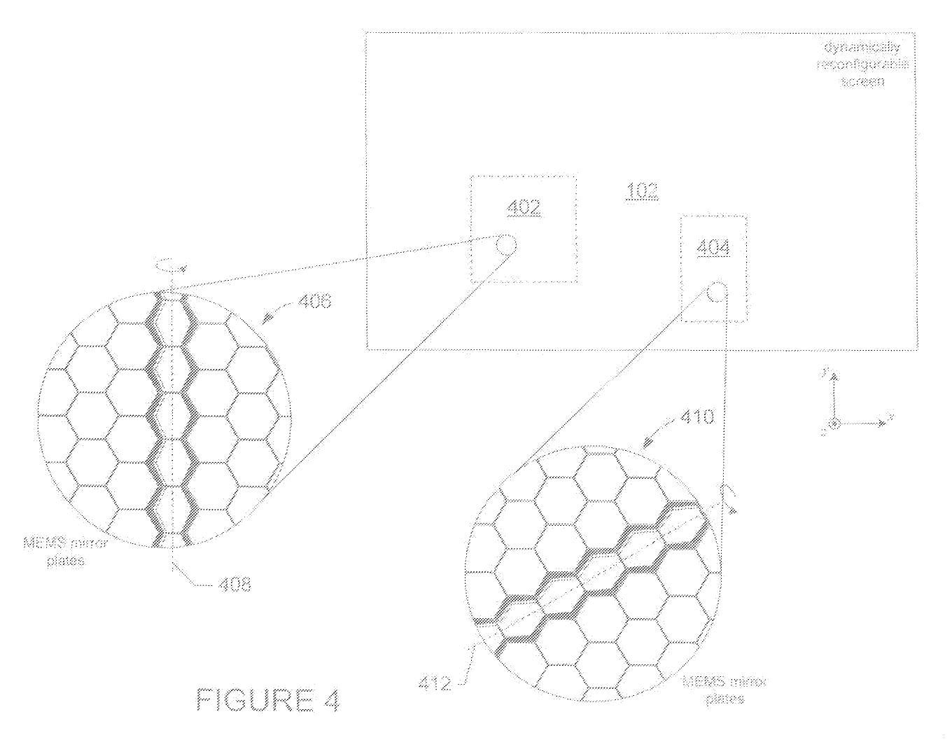

In other embodiments, sub-regions of mirror plates can be rotated simultaneously into the same orientation, enabling different portions of images projected onto the screen 102 to be reflected in different directions. FIG. 4 shows two example sub-regions 402 and 404 of the screen 102. Each of the sub-regions 402 and 404 has an associated enlargement 406 and 408 revealing a different rotational orientation of the mirror plates located within a corresponding sub-region. For example, enlargement 406 shows a column of minor plates located within the sub-region 402 rotated along an imaginary axis 408 in the y-direction. Enlargement 410 shows that mirror plates located in the sub-region 404 rotated about an axis 412 extending 30° above the x-direction.

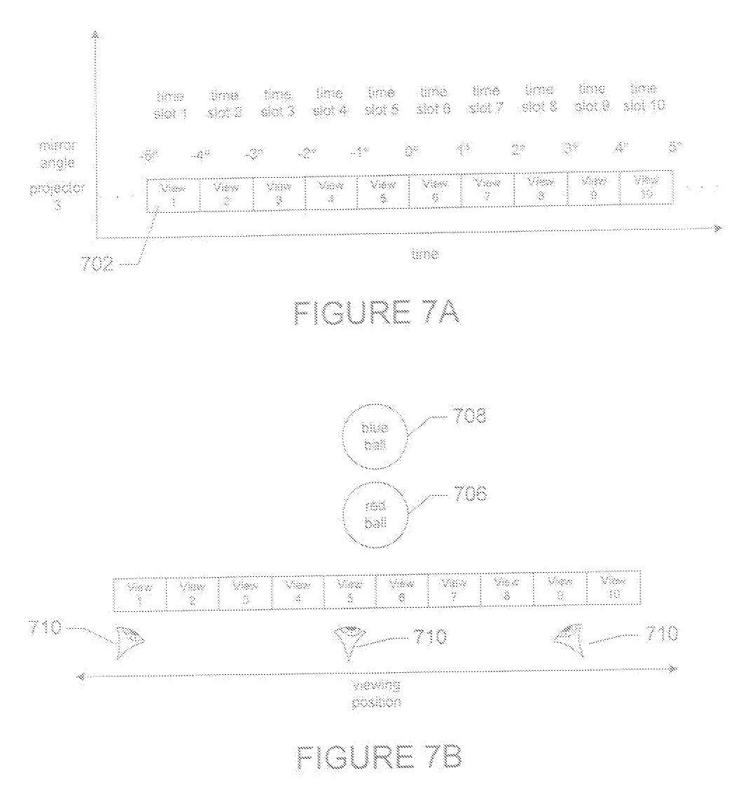

Dynamically reconfiguration screen embodiments are not limited to the mirror plates having the same equilibrium angle of rotation of 0° about which the mirror plates are rotated. In other embodiments, the mirror plates can be configured with different equilibrium angles of rotation about which the minor plates are rotated, an example of which as described in greater detail below with reference to FIG. 7.

### Various Image Viewing System Embodiments

The viewing system 100 can be configured and operated as multiview display by presenting a viewer with different two-dimensional views of the same scene projected onto the screen 102 from different viewing perspectives. The result is that the viewer perceives a three-dimensional experience of the scene displayed on the screen 102 by viewing the screen 102 from different viewing zones, each viewing zone associated with a different two-dimensional perspective view of the scene.

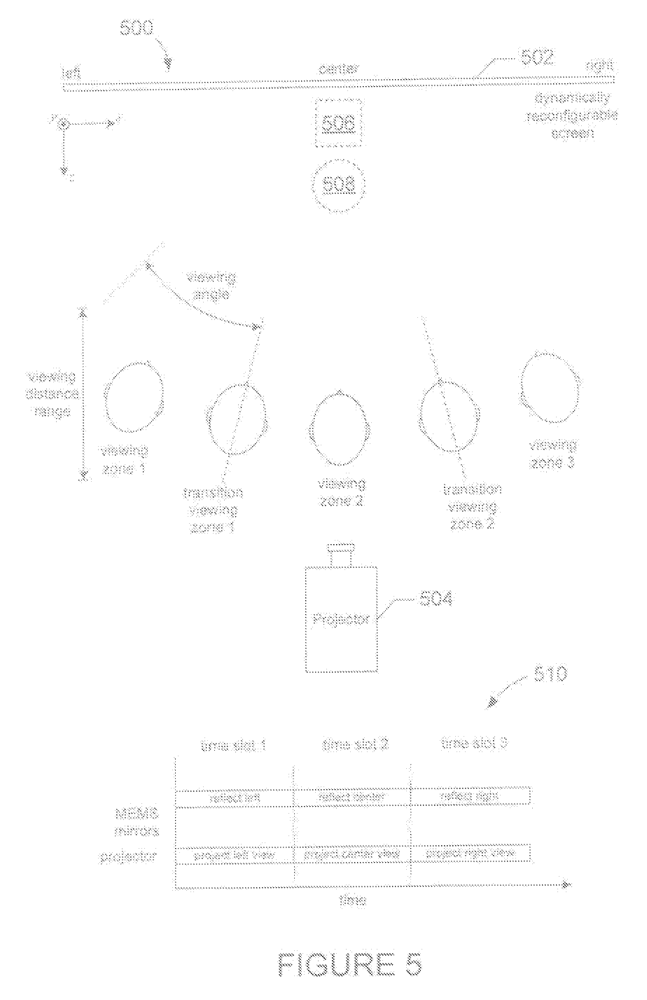

FIG. 5 shows a top view of a schematic representation of a viewing system 500 configured in accordance with embodiments of the present invention. The viewing system 500 includes the screen 502 and a projection system 504. FIG. 5 also identities three different two-dimensional viewing zones that lie within the xz-plane: viewing zone I, viewing zone 2, and viewing zone 3. The viewing zones have a range of viewing distances and an associated range of viewing angles. A viewer looking at the screen 502 from a viewing zone sees one of the different two-dimensional perspective views of the scene projected onto the screen 502. Images of different perspective views of a scene are synchronized with rotating the mirror plates of the screen 502 into a particular angle of rotation. Synchronizing images of different perspective views with the angle of the mirror plates can be accomplished using time-division multiplexing described as follows.

For the sake of simplicity of illustration, and not by way of limitation consider, for example, projecting a scene composed of three different two-dimensional perspective views of the same two objects: a cylinder 508 positioned in front of a cube 510 with the axis of the cylinder 508 extending in the y-direction. Each image of a perspective view is projected onto the screen 502 within a separate and approximately equal duration time slot using the projector 504. FIG. 5 includes a plot 510 of three time slots, each time slot corresponding to synchronized operations performed by the screen 502 and the projector 504. In time slot 1, the projector 504 projects a left perspective view of the objects 506 and 508 onto the screen 502 so that a viewer looking at the screen 502 from viewing zone 1 sees a left perspective view of the scene. In time slot 2, the projector 504 projects a center perspective view of the objects 506 and 508 onto the screen 502 so that a viewer viewing the screen 502 from viewing zone 2 sees a center view of the scene. In time slot 3, the projector 504 projects a right perspective view of the objects 508 and 508 onto the screen 502 so that a viewer looking at the screen 502 from viewing zone 3 sees a right perspective view of the scene. At the beginning of each time slot, the columns of mirror plates of the screen 502 are simultaneously rotated with the same angle of rotation in order to reflect each perspective view to a corresponding viewing zone. At the beginning of time slot 1 the mirror plates are rotated to reflect the image of the left perspective view toward viewing zone 1; at the beginning of time slot 2, the mirror plates are rotated to 0° to reflect the image of the center perspective view toward viewing zone 2; and at the beginning of time slot 3, the mirror plates are rotated to reflect the image of the right perspective view toward viewing zone 3.

In order for a viewer positioned at any one of the three viewing zones to perceive a continuous image of the Objects 506 and 508 without image flicker, the operations performed in the three times slots are repeated with a frequency greater than 60 Hz. As a result, a viewer initially located at viewing zone 1 sees a first two-dimensional view of the cylinder 508 located to the right of the cube 506. When the viewer moves to viewing zone 2, the viewer sees only a second two-dimensional view of the cylinder 508, because the cylinder 508 blocks the view of the cube 506. When the viewer moves to viewing zone 3, the viewer sees a third two-dimensional view of the cylinder 508 located to the left of the cube 506. In other words, the viewer is able to observe a three-dimensional image of the objects 506 and 508 from a different perspective by changing viewing zones.

The viewing system 500 may also he operated to provide a viewer three-dimensional perspective views when the viewer is located in transition viewing zones. For example, the example viewing system 500 shown in FIG. 5 creates two transition viewing zones identified as transition viewing zone 1 and transition viewing zone 2. At a transition viewing zone, a three-dimensional perspective view may he created when a first two-dimensional image associated with a first viewing zone enters one eye of a viewer and a second two-dimensional image associated with a second viewing zone enters the other eye of the viewer. In other words, the first and second two-dimensional images form a stereo images pair for a viewer straddling two viewing zones. For example, as shown in FIG. 5, a viewer located at viewing zone 1 receives the two-dimensional image associated with viewing zone 1 in the viewer's left eye and the two-dimensional image associated with viewing zone 2 in the viewer's right eye. The two images form left-eye and right-eye stereo image pairs, enabling the viewer to perceive a three-dimensional perspective view of the cylinder 508 and the square 508 from transition viewing zone 1.

The example viewing system 500 provides three two-dimensional perspective views that can be viewed from three different viewing zones and provides two three-dimensional perspective views that can be viewed from two different transition viewing zones.

The example described above for creating multiple two-dimensional and three-dimensional perspective views of Objects or a scene as the viewer looks at the screen 102 from different viewing zones is described using only three different viewing zones. However, in practice, using only three different viewing zones creates abrupt changes in the images presented to the viewer as the viewer moves from one viewing zone to the next. In order to create a smoother visual transition in the images as the viewer changes position, the imaging system can be operated to present more than three different views, each view observed from a different viewing zone. For example, the imaging system 500 can be operated to provide five different viewing zones, each viewing zone providing a different two-dimensional perspective view of the same scene and potentially four different three-dimensional perspective views at four transition viewing zones. This can be accomplished as described above but with five different time slots and five different two-dimensional perspective views of the scene. Each time slot corresponds to projecting an image of one of the five different perspective views and is synchronized with rotating mirror plates into the appropriate orientation to reflect the image to the corresponding viewing zone. In order for each viewing zone to provide a continuous image without image flicker, the operations performed in the five time slots are repeated with a frequency greater than 60 Hz.

Embodiments of the present invention are not limited to viewing different perspective views of the same scene from three different viewing zones. In other embodiments, the screen. 502 and projector 504 can be operated to present a different scene for each time slot, enabling the viewer to move from one viewing zone to the next and see entirely different scenes or different objects from the different viewing zones. Similarly, three viewers located at the three viewing zones would see different scenes. In other words, three different movies can be shown at the same time provided the audio can be isolated for each viewing zone, such as by equipping each viewer with headphones. Embodiments of the present invention are also not limited to viewing the screen 502 from within the xz-plane. For example, the mirror plates can also be rotated about axes that run parallel to the x-direction for viewing perspective views of objects or a scene from within the yz-plane. The mirror plates can also be rotated about axes that are not parallel to either the x- or y-directions in order to project perspective views in planes other than the xz- and yz-planes.

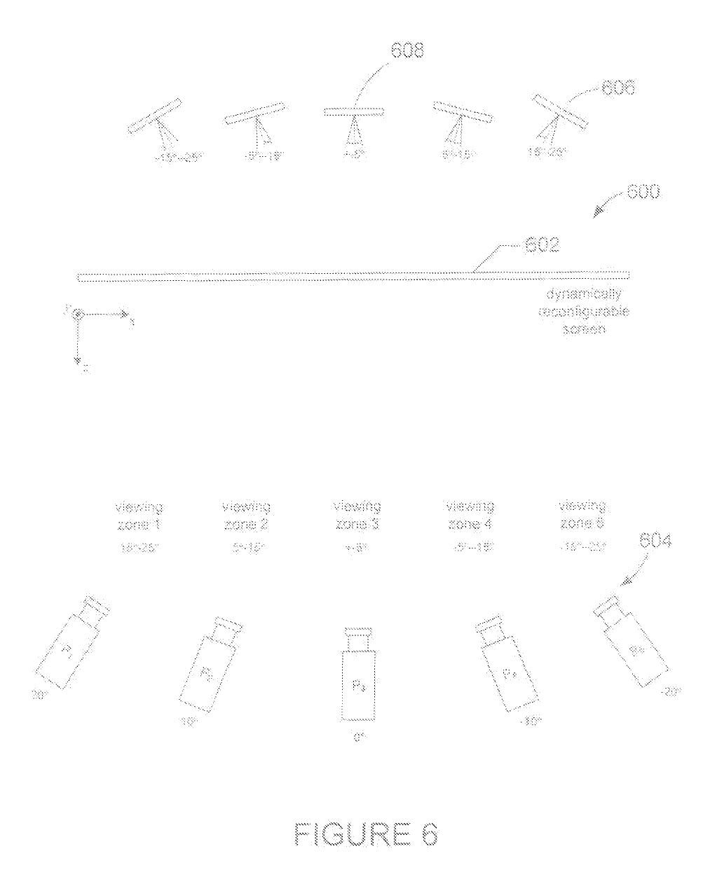

FIG. 6 shows a top plan view of a viewing system 600 comprising a dynamically reconfigurable screen 602 and a projection system 604, which is comprised of five projectors denoted by P₁, P₂, P₃, P₄, and P₅. The screen 602 is configured and operated so that columns of mirror plates are continuously and simultaneously rotated back and forth between operating angles of about +25° and about −25°, with 0° corresponding to the mirror plates lying parallel to the xy-plane of the screen 602. The projectors P₁, P₂, P₃, P₄, and P₅ all simultaneously project a series of perspective view images onto the screen 602. The perspective views create a light field associated with a scene projected onto the screen, enabling a viewer to see different perspective views of a scene projected onto the screen 604 from different viewing positions. Each projector is angled to project a series of perspective view images onto the screen so that as the mirror plates pass through an associated range of sub-angles, the perspective views are reflected to an associated viewing zone. For example, projector P₁ is angled at 20° 606. As the mirror plates rotate through the range of sub-angles 15° to 25°, the series of perspective view images generated by the projector P₁ are reflected to viewing zone 1. Projector P₃ is angled at 0°. As the mirror plates pass through the range of sub-angles −5° to 5° 608, the series of perspective view images generated by the projector P₃ are reflected to viewing zone 3. A viewer located in a particular viewing zone and looking as the screen 602 sees the perspective view images projected onto the screen by one projector as the mirror plates rotate through a corresponding range of sub-angles.

Each projector sequentially displays a series of different perspective view images of a scene or objects that create a two-dimensional or three-dimensional perspective view of the scene depending on where the viewer is located within a viewing zone. Each perspective view image is projected within a time slot. FIG. 7A shows a plot of 10 example time slots associated a series of different perspective view images projected by the projector 3. The time slots are of approximately equal duration. Within each time slot, the projector 3 projects a different two-dimensional perspective view image of a scene onto the screen 602, identified as view 1, view 2, etc. While the perspective view is projected onto the screen 602, the mirror plates rotate through angles 31 5° and 5°. For example, as the mirror plates rotate from the angle −5° to the angle −4° projector 3 projects perspective view 1 702, which is reflected to a particular viewing position within viewing zone 3, shown in FIG. 6.

Each perspective view is a narrow band of light that enters one of the viewer's eyes when the viewer is located at a particular viewing position within a viewing zone. FIG. 7B shows an example of the perspective views 1-10 of a red ball 706 and a blue ball 708 shown in FIG. 7A. When viewing the screen 602 from a particular viewing position within viewing zone 3, perspective view 1 enters one eye 710 of the viewer, which shows the blue ball 708 to the left and behind the red ball 706. But as the viewer changes viewing positions within viewing zone 3, different perspective views enter the viewer's eye 710. For example, when the viewer moves to a different viewing position within viewing zone 3, perspective view 5 enters the viewer's eye 710, which shows the red ball 706 almost completely blocking the view of the blue ball 708. And when the viewer moves to a different viewing position within viewing zone 3, perspective view 9 enters the viewer's eye 710, which shows the blue ball 708 to the right and behind the red ball 706.

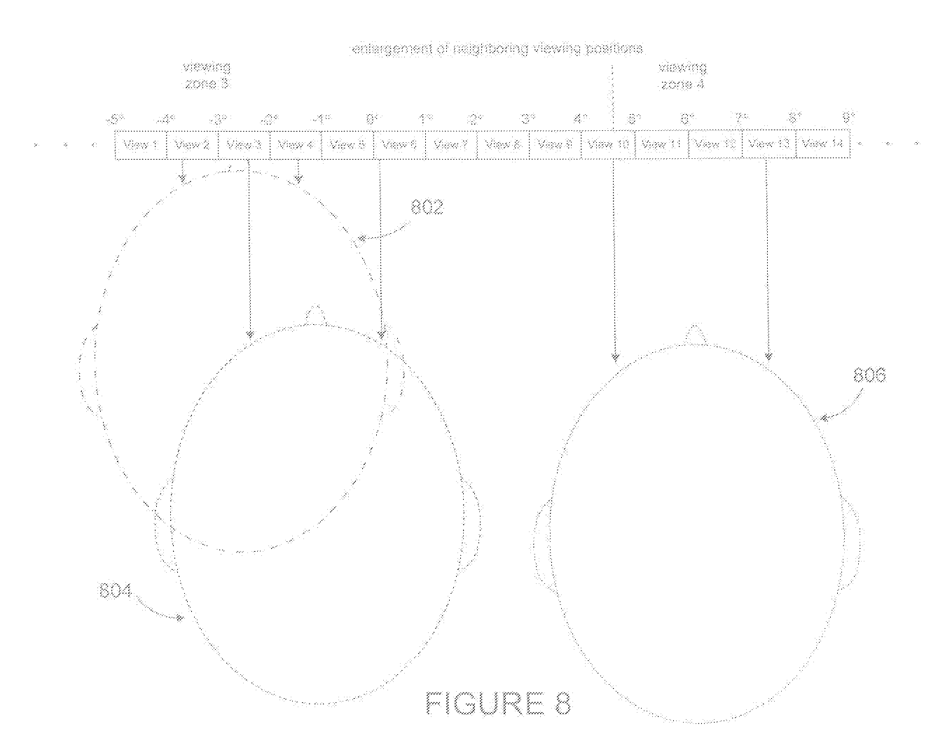

Depending on where the viewer is located within a viewing zone, two perspective views, each entering one of the viewer's eyes, create either a three-dimensional perspective view or a two-dimensional perspective view of the scene or objects projected onto the screen 602. FIG. 8 shows a top view of a viewer capturing different perspective views in each eye for different viewing positions within two neighboring viewing zones. When the viewer is located at a first viewing position 802, perspective view 2 enters the viewer's left eye and perspective view 4 enters the viewer's right eye. If the views 2 and 4 overlap to a large extent, the viewer perceives a two-dimensional perspective view of the scene displayed. When the viewer moves to a different viewing position 804, perspective view 3 enters the viewer's left eye and perspective view 6 enters the viewer's right eye. The views 3 and 6 in this case are sufficiently far apart to form a stereo right-eye and left-eye image pair, enabling the viewer to perceive a three-dimensional perspective view of the scene displayed on the screen 602. FIG. 8 also shows the viewer straddling two different viewing zones in a viewing zone 806. Neighboring perspective views 10 and 11 enter the viewer's left eye, and neighboring perspective views 13 and 14 enter the views right eye. Neighboring views 10 and 11 overlap to a great extent and the neighboring views 13 and 14 overlap to a great extent, and the viewer's brain averages the two neighboring views entering each eye to produce either a two-dimension perspective view or three-dimensional perspective view, depending on the extent to which the averaged perspective views overlap.

Note that embodiments of the present invention are not limited to reflecting a perspective view over a one degree angle of rotation, as described above. The one degree angle of rotation by which the perspective views are reflected as and described above, is selected for convenience of description. In practice, the range of angles over which a perspective view is reflected can be any suitable angle, such as one degree, less than one degree, or greater than one degree.

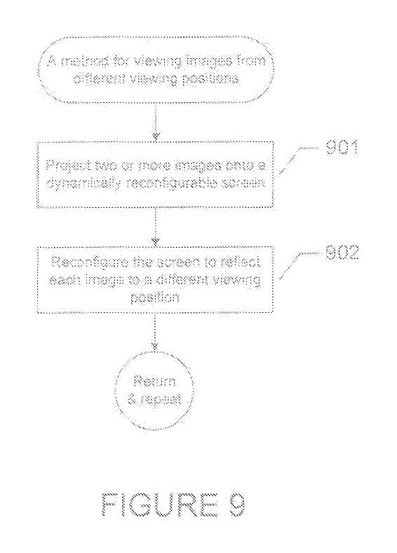

FIG. 10 shows a flow diagram of a method for viewing images from different viewing zones. In step 1001, two or more images are projected onto a dynamically reconfigurable screen. Each image provides a different perspective view of objects or a scene. In certain embodiments, the images can be projected onto the screen in separate but approximately equal time slots using time-division multiplexing, as described above with reference to the viewing system shown in FIG. 5. In other embodiments, the images can be stereo image pairs, each image pair representing a different three-dimensional perspective view of the objects or the scene, as described above with reference to FIGS. 7-10. In step 1002, the screen is dynamically reconfigured to reflect each image to a different viewing zone. A viewer looking at the screen from each viewing zone sees a different perspective view of the objects or the scene. In certain embodiments, the screen can be dynamically reconfigured to reflect each image in a separate time slot as described above with reference to the viewing system shown in FIG. 5. In other embodiments, the screen can be dynamically reconfigured to reflect stereo image pairs toward different associated viewing zones. A viewer looking at the screen from each viewing zone sees a different three-dimensional perspective view of the objects or the scene.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purposes of illustration and description. They are not intended to be exhaustive of or to limit the invention to the precise forms disclosed. Obviously, many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention he defined by the following claims and their equivalents:

1. An image viewing system comprising:
a projection system (104, 504, 604); and
a dynamically reconfigurable screen (102, 502, 602), wherein the projection system projects two or more images onto the screen, and wherein the screen is dynamically reconfigured to separately reflect each image to a different associated viewing zone, enabling a viewer looking at the screen to view each image from a different viewing zone.

2. The system of claim 1, wherein the projection system further comprises a single video projector (504) operated to project each image in a separate and approximately equal duration time slot.

3. The system of claim 1, wherein the dynamically reconfigurable screen (502) further comprises:
a substrate (210);
an actuator layer (212) disposed on the substrate; and
an array of mirror plates (206) coupled to the actuator layer such that the actuator layer is configured and operated to reorient the mirror plates to reflect each image to an associated viewing zone.

4. The system of claim 3, wherein the actuator layer can be operated to rotate the mirror plates to reflect each of the two or more images to an associated viewing zone.

5. The system of claim 1, wherein the dynamically reconfigurable screen further comprises:
a substrate (210);
an actuator layer (21 disposed on the substrate; and
an array of mirror plates coupled to the actuator layer, wherein the array of mirror plates is partitioned into segments, each segment including mirror plates that are rotated about different equilibrium positions.

6. The system of claim 5, wherein the actuator layer can be operated to rotate each mirror plate about an associated equilibrium position within each segment to reflect each of the two or more images to a different associated viewing zone.

7. The system of claim 1, wherein the projection system further comprises a projector (504) operated to project a perspective view onto the screen such that a viewer looking at the screen from a viewing zone views a reflected two-dimensional perspective image.

8. The system of claim 1, wherein the projection system (604) further comprises one or more projectors, wherein each projector is operated to project a series of different perspective view images onto the screen such that a viewer looking at the screen from a viewing zone receives a first perspective view in the viewer's left eye and a second perspective view in the viewer's right eye.

9. The system of claim 6, wherein the first perspective view in the viewer's left eye and the second perspective view in the viewer's right eye form a stereo image pair providing the viewer with a three-dimensional, perspective view image of a scene projected onto the screen.

10. The system of claim 6, wherein the first perspective view in the viewer's left eye and the second perspective view in the viewer's right eye form a two-dimensional, perspective view image of a scene projected onto the screen,

11. A method for viewing two or more images from different viewing zones, the method comprising:
projecting the two or more images onto a dynamically reconfigurable screen (1001);
dynamically reconfiguring the screen to reflect each image to a different viewing zone (1002), wherein a viewer looking at the screen from each viewing zone sees one of the two or more images.

12. The method of claim 11, wherein projecting two or more images onto the dynamically reconfigurable screen further comprises projecting each image onto the screen within a separate time slot.

13. The method of claim 11, wherein dynamically reconfiguring the screen further comprises reconfiguring the screen to reflect each image toward an associated viewing zone within separate time slots, wherein a viewer looking at the screen from each viewing zone sees a different two-dimensional perspective view of the Objects or the scene.

14. The method of claim 11, wherein projecting two or more images onto the dynamically reconfigurable screen further comprises projecting two or more stereo image pairs onto the screen.

15. The method of claim 11, wherein dynamically reconfiguring the screen to reflect each image to a different viewing zone further comprises dynamically reconfiguring the screen to reflect stereo image pairs toward an associated viewing zone, wherein a viewer looking at the screen from each viewing zone sees a different three-dimensional perspective view of the scene projected onto the screen.
